(19) United States
(12) Patent Application Publication
(10) Pub. No.: US 2018/0100040 A1
(43) Pub. Date: Apr. 12, 2018

(54) SILICONE ELASTOMER COMPOSITIONS, COMPOSITE MATERIALS, AND METHODS

(71) Applicant: EQUISTAR CHEMICALS, LP, HOUSTON, TX (US)

(72) Inventor: Karl M. Brown, Maineville, OH (US)

(73) Assignee: EQUISTAR CHEMICALS, LP, HOUSTON, TX (US)

(21) Appl. No.: 15/725,044

(22) Filed: Oct. 4, 2017

Related U.S. Application Data
(60) Provisional application No. 62/405,354, filed on Oct. 7, 2016.

(51) Int. Cl. C08J 3/20; C08L 23/08; C08J 3/00; C09K 21/02; H01B 1/02; H01B 7/02

(52) U.S. Cl. CPC C08J 3/203; C08L 23/0853; C08J 3/005; C09K 21/02; C08J 2483/04; H01B 7/02; C08L 2201/02; C08J 2323/08; H01B 1/026

(57) ABSTRACT

Provided herein are compositions and methods of forming compositions that include ethylene-vinyl acetate, alumina trihydrate, a peroxide, and an ultra-high molecular weight (UHMW) silicone elastomer. The UHMW silicone elastomer may be added after the other components of the composition have been added in the methods provided herein. Also provided herein are composite materials that include a wire.

### CROSS-REFERENCE TO RELATED APPLICATIONS

This application is the Non-Provisional patent application, which claims benefit of priority to U.S. Provisional Application No. 62/405,354, filed Oct. 7, 2014, the contents of which are incorporated herein by reference in their entirety.

### BACKGROUND

Fire resistant polymer compositions are used for wire and cable insulation. In electrical environments, these polymers may have insulating properties in addition to fire retardant properties. The composition may also have resistance to deterioration under service conditions.

Crosslinkable polymers, such as ethylene-vinyl acetate copolymers have been used as fire retarding insulation for wire and cable is comprised of a crosslinkable polymer, such as, Additives included in fire resistant polymer compositions have included one or more silanes, one or more hydrated inorganic fillers, a crosslinking agent, pigments, processing oils, lubricants, stabilizers, and/or antioxidants. Compositions of this type which find use as insulation and jacketing for copper wire are disclosed in U.S. Pat. Nos. 3,832,326 and 3,922,442 to North et al. and U.S. Pat. Nos. 4,349,605 and 4,381,362 to Biggs et al.

### BRIEF SUMMARY

Provided herein are compositions and methods of forming compositions. In embodiments, the methods of forming a composition comprise combining ethylene-vinyl acetate, alumina trihydrate, and a peroxide to form a mixture; heating the mixture to a first temperature of at least 150° F. to form a processed mixture; and combining the processed mixture with an ultra high molecular weight (UHMW) silicone elastomer to form the composition. The composition, in one embodiment, comprises ethylene-vinyl acetate in an amount of about 35 to about 55 weight percent by weight of the composition, alumina trihydrate in an amount of about 45 to about 65 weight percent by weight of the composition, a peroxide in an amount of about 0.3 to about 0.8 weight percent by weight of the composition, and the UHMW silicone elastomer in an amount of about 0.1 to about 3.0 weight percent by weight of the composition, wherein the amounts of ethyl-vinyl acetate, alumina trihydrate, peroxide and UHMW silicone elastomer equal 100 percent by weight.

Also provided herein are composite materials. In embodiments, the composite materials comprise a wire, and a composition disposed on at least a portion of the wire. The composition, in one embodiment, is made according to the methods provided herein. In another embodiment, the composition is made according to the methods provided herein, and comprises ethylene-vinyl acetate in an amount of about 35 to about 55 weight percent by weight of the composition, alumina trihydrate in an amount of about 45 to about 65 weight percent by weight of the composition, a peroxide in an amount of about 0.3 to about 0.8 weight percent by weight of the composition, and a UHMW silicone elastomer in an amount of about 0.1 to about 3.0 weight percent by weight of the composition.

### BRIEF DESCRIPTION OF THE FIGURE

FIG. 1 is a schematic showing the setup of the FT2 flame test performed at Example 2.

### DETAILED DESCRIPTION

Provided herein are compositions comprising ethylene-vinyl acetate and alumina trihydrate that have enhanced char strength. In various embodiments, the char strength of the compositions provided herein can be improved by delaying the addition of a UHMW silicone elastomer during processing. For example, the char strength of the compositions provided herein and composite materials comprising the compositions provided herein is improved, in embodiments, by combining ethylene-vinyl acetate, alumina trihydrate, and a peroxide to form a mixture, processing the mixture, for example, by heating the mixture to form a processed mixture, and then combining the processed mixture with a UHMW silicone elastomer to form a composition.

While the present invention may be embodied in many different forms, disclosed herein are specific illustrative embodiments thereof that exemplify the principles of the invention. It should be emphasized that the present invention is not limited to the specific embodiments disclosed herein.

In embodiments, the compositions provided herein include ethylene-vinyl acetate, alumina trihydrate, a peroxide, and a UHMW silicone elastomer.

Generally, the UHMW silicone elastomer may include one or more commercially available UHMW silicone elastomers. In embodiments, the UHMW silicone elastomer is a polymer that includes a siloxane monomer, and has a number average molecule weight of at least 100,000 g/mol, at least 250,000 g/mol, at least 300,000 g/mol, at least 400,000 g/mol, or at least 500,000 g/mol. The UHMW silicone elastomer may have a number average molecule weight of about 100,000 g/mol to about 1,000,000 g/mol, about 250,000 g/mol to about 1,000,000 g/mol, about 300,000 g/mol to about 1,000,000 g/mol, about 400,000 g/mol to about 1,000,000 g/mol, or about 500,000 g/mol to about 1,000,000 g/mol. In one embodiment, the UHMW silicone elastomer of the compositions provided herein comprises GENIOPLAST® Pellet S UHMW silicone elastomer (Wacker, Munich, Germany). GENIOPLAST® Pellet S UHMW silicone elastomer is available as a pelletized silicone gum formulation that may include a siloxane polymer and fumed silica. In embodiments, the compositions provided herein comprise UHMW silicone elastomer in an amount of about 0.1 to about 3.0 weight percent by weight of the composition. In further embodiments, the compositions provided herein comprise UHMW silicone elastomer in an amount of about 0.5 to about 2.5 weight percent by weight of the composition. In some embodiments, the compositions provided herein comprise UHMW silicone elastomer in an amount of about 1.0 to about 2.0 weight percent by weight of the composition. In still further embodiments, the compositions provided herein comprise UHMW silicone elastomer in an amount of about 1.0 to about 1.5 weight percent by weight of the composition.

Generally, the ethylene-vinyl acetate may be any commercially available ethylene-vinyl acetate, or a combination of commercially available ethylene-vinyl acetate products. In embodiments, the ethylene-vinyl acetate is a copolymer that includes an ethylene monomer and a vinyl acetate monomer. In one embodiment, the ethylene-vinyl acetate comprises ULTRATHENE® UE624000 ethylene-vinyl acetate (LyondellBasell, Texas, USA). ULTRATHENE® UE624000 ethylene-vinyl acetate has a vinyl acetate content of 18%, and an equivalent melt index of 2.1 g/10 min. In embodiments, the compositions provided herein comprise ethylene-vinyl acetate in an amount of about 35 to about 55 weight percent by weight of the composition. In other embodiments, the compositions provided herein comprise ethylene-vinyl acetate in an amount of about 40 to about 50 weight percent by weight of the composition. In further embodiments, the compositions provided herein comprise ethylene-vinyl acetate in an amount of about 40 to about 45 weight percent by weight of the composition. In particular embodiments, the compositions provided herein comprise ethylene-vinyl acetate in an amount of about 42 to about 44 weight percent by weight of the composition.

Generally, the alumina trihydrate may be any commercially available alumina trihydrate, or a combination of commercially available alumina trihydrate products. In one embodiment, the alumina trihydrate comprises HYDRAL® PGA-SD alumina trihydrate (J.M. Huber, Georgia, USA). HYDRAL® PGA-SD alumina trihydrate typically includes Al(OH)3 (99.5%), SiO2 (0.004%), Fe2O3 (0.007%), Na2O (0.24%), and moisture (0.17%), and is available in spray-dried form. In embodiments, the compositions provided herein comprise alumina trihydrate in an amount of about 45 to about 65 weight percent by weight of the composition. In further embodiments, the compositions provided herein comprise alumina trihydrate in an amount of about 50 to about 60 weight percent by weight of the composition. In other embodiments, the compositions provided herein comprise alumina trihydrate in an amount of about 50 to about 55 weight percent by weight of the composition. In still further embodiments, the compositions provided herein comprise alumina trihydrate in an amount of about 52 to about 54 weight percent by weight of the composition.

Generally, the peroxide may be any commercially available peroxide, or a combination of commercially available peroxides. In one embodiment, the peroxide is a bis-peroxide. In another embodiment, the peroxide is a crosslinking peroxide. In a further embodiment, the peroxide is a crosslinking bis-peroxide. In a particular embodiment, the peroxide comprises VULCUP® R crosslinking peroxide (Arkema, Pennsylvania, USA). VULCUP® R crosslinking peroxide is a bis-peroxide that typically has a bis-peroxide content of at least 95%, and a specific gravity at 25/25° C. of 0.95. In embodiments, the composition comprises the peroxide in an amount of about 0.3 to about 0.8 weight percent by weight of the composition. In further embodiments, the composition comprises the peroxide in an amount of about 0.4 to about 0.7 weight percent by weight of the composition. In other embodiments, the composition comprises the peroxide in an amount of about 0.5 to about 0.7 weight percent by weight of the composition. In still further embodiments, the composition comprises the peroxide in an amount of about 0.5 to about 0.6 weight percent by weight of the composition.

In embodiments, the compositions provided herein comprise UHMW silicone elastomer in an amount of about 0.1 to about 3.0 weight percent by weight of the composition, ethylene-vinyl acetate in an amount of about 35 to about 55 weight percent by weight of the composition, alumina trihydrate in an amount of about 45 to about 65 weight percent by weight of the composition, and a peroxide in an amount of about 0.3 to about 0.8 weight percent by weight of the composition. In further embodiments, the compositions provided herein comprise UHMW silicone elastomer in an amount of about 0.5 to about 2.5 weight percent by weight of the composition, ethylene-vinyl acetate in an amount of about 40 to about 50 weight percent by weight of the composition, alumina trihydrate in an amount of about 50 to about 60 weight percent by weight of the composition, and a peroxide in an amount of about 0.4 to about 0.7 weight percent by weight of the composition. In additional embodiments, the compositions provided herein comprise UHMW silicone elastomer in an amount of about 1.0 to about 2.0 weight percent by weight of the composition, ethylene-vinyl acetate in an amount of about 40 to about 45 weight percent by weight of the composition, alumina trihydrate in an amount of about 50 to about 55 weight percent by weight of the composition, and a peroxide in an amount of about 0.5 to about 0.7 weight percent by weight of the composition. In some embodiments, the compositions provided herein comprise UHMW silicone elastomer in an amount of about 1.0 to about 2.0 weight percent by weight of the composition, ethylene-vinyl acetate in an amount of about 42 to about 44 weight percent by weight of the composition, alumina trihydrate in an amount of about 52 to about 54 weight percent by weight of the composition, and a peroxide in an amount of about 0.5 to about 0.6 weight percent by weight of the composition. In still further embodiments, the compositions provided herein comprise UHMW silicone elastomer in an amount of about 1.0 to about 1.5 weight percent by weight of the composition, ethylene-vinyl acetate in an amount of about 42 to about 44 weight percent by weight of the composition, alumina trihydrate in an amount of about 52 to about 54 weight percent by weight of the composition, and a peroxide in an amount of about 0.5 to about 0.6 weight percent by weight of the composition.

The compositions provided herein can include one or more additives. The additives may include one or more antioxidants, one or more processing aids, or a combination thereof. Each of the one or more additives generally may be present independently in the compositions provided herein in an amount of about 0.01 to about 1.0 weight percent by weight of the composition. The additives may be selected from one or more antioxidants, one or more silane coupling agents, one or more waxes, one or more surfactants, or a combination thereof. The one or more antioxidants may include a phenolic antioxidant, such as IRGANOX® 1010 antioxidant (BASF, Germany), a sulfur-containing antioxidant, such as NAUGARD® 412s thioester antioxidant (Addivant, Connecticut, USA), or a combination thereof. IRGANOX® 1010 is a sterically hindered primary phenolic antioxidant. NAUGARD® 412s is an organic sulfur-containing antioxidant having the chemical name pentaerythritol tetrakis (β-laurylthiopropionate). The one or more silane coupling agents may comprise vinyltrimethoxysilane (VTMO), such as GENIOSIL® XL 10 VTMO (Wacker, Munich, Germany), vinyltriethoxysilane (VTEO), or a combination thereof. GENIOSIL® XL 10 has a molecular weight of 148.2 g/mol, and its CAS Number is 2768-02-7. The one or more waxes may comprise ethylene bis(stearamide). The one or more surfactants may comprise a saturated fatty acid, such as lauric acid. The additives also may include zinc oxide. Other additives that may be included in the compositions provided herein include colorants and/or other cosmetic additives. Other additives are envisioned.

In embodiments, the compositions provided herein include the following additives: a phenolic antioxidant, a sulfur-containing antioxidant, a silane coupling agent, a wax, a surfactant, and zinc oxide. In other embodiments, the compositions provided herein include the following additives: a phenolic antioxidant, a sulfur-containing antioxidant, a silane coupling agent, a wax, and a surfactant.

In embodiments, the compositions provided herein include the following additives: a phenolic antioxidant in an amount of about 0.8 to about 1.0 weight percent by weight of the composition, a sulfur-containing antioxidant in an amount of about 0.05 to about 0.15 weight percent by weight of the composition, a silane coupling agent in an amount of about 0.2 to about 0.5 weight percent by weight of the composition, a wax in an amount of about 0.25 to about 0.4 weight percent by weight of the composition, a surfactant in an amount of about 0.05 to about 2.0 weight percent by weight of the composition, and zinc oxide in an amount of about 0.4 to about 0.6 weight percent by weight of the composition. In further embodiments, the compositions provided herein include the following additives: a phenolic antioxidant in an amount of about 0.8 to about 1.0 weight percent by weight of the composition, a sulfur-containing antioxidant in an amount of about 0.05 to about 0.15 weight percent by weight of the composition, a silane coupling agent in an amount of about 0.2 to about 0.5 weight percent by weight of the composition, a wax in an amount of about 0.25 to about 0.4 weight percent by weight of the composition, and a surfactant in an amount of about 0.05 to about 2.0 weight percent by weight of the composition.

In embodiments, the compositions provided herein include the following additives: IRGANOX® 1010 (BASF, USA) phenolic antioxidant in an amount of about 0.8 to about 1.0 weight percent by weight of the composition, NAUGARD® 412S (Addivant, Connecticut, USA) sulfur-containing antioxidant in an amount of about 0.05 to about 0.15 weight percent by weight of the composition, GENIOSIL® XL 10 VTMO in an amount of about 0.2 to about 0.5 weight percent by weight of the composition, ethylene bis(stearamide) wax in an amount of about 0.25 to about 0.4 weight percent by weight of the composition, lauric acid in an amount of about 0.05 to about 2.0 weight percent by weight of the composition, and zinc oxide in an amount of about 0.4 to about 0.6 weight percent by weight of the composition.

In embodiments, the compositions provided herein comprise UHMW silicone elastomer in an amount of about 0.1 to about 3.0 weight percent by weight of the composition, ethylene-vinyl acetate in an amount of about 35 to about 55 weight percent by weight of the composition, alumina trihydrate in an amount of about 45 to about 65 weight percent by weight of the composition, a peroxide in an amount of about 0.3 to about 0.8 weight percent by weight of the composition, a phenolic antioxidant in an amount of about 0.8 to about 1.0 weight percent by weight of the composition, a sulfur-containing antioxidant in an amount of about 0.05 to about 0.15 weight percent by weight of the composition, a silane coupling agent in an amount of about 0.2 to about 0.5 weight percent by weight of the composition, a wax in an amount of about 0.25 to about 0.4 weight percent by weight of the composition, a surfactant in an amount of about 0.05 to about 2.0 weight percent by weight of the composition, and zinc oxide in an amount of about 0.4 to about 0.6 weight percent by weight of the composition.

In embodiments, the compositions provided herein comprise UHMW silicone elastomer in an amount of about 0.5 to about 2.5 weight percent by weight of the composition, ethylene-vinyl acetate in an amount of about 40 to about 50 weight percent by weight of the composition, alumina trihydrate in an amount of about 50 to about 60 weight percent by weight of the composition, a peroxide in an amount of about 0.4 to about 0.7 weight percent by weight of the composition, a phenolic antioxidant in an amount of about 0.8 to about 1.0 weight percent by weight of the composition, a sulfur-containing antioxidant in an amount of about 0.05 to about 0.15 weight percent by weight of the composition, a silane coupling agent in an amount of about 0.2 to about 0.5 weight percent by weight of the composition, a wax in an amount of about 0.25 to about 0.4 weight percent by weight of the composition, a surfactant in an amount of about 0.05 to about 2.0 weight percent by weight of the composition, and zinc oxide in an amount of about 0.4 to about 0.6 weight percent by weight of the composition.

In additional embodiments, the compositions provided herein comprise UHMW silicone elastomer in an amount of about 1.0 to about 2.0 weight percent by weight of the composition, ethylene-vinyl acetate in an amount of about 40 to about 45 weight percent by weight of the composition, alumina trihydrate in an amount of about 50 to about 60 weight percent by weight of the composition, a peroxide in an amount of about 0.5 to about 0.7 weight percent by weight of the composition, a phenolic antioxidant in an amount of about 0.8 to about 1.0 weight percent by weight of the composition, a sulfur-containing antioxidant in an amount of about 0.05 to about 0.15 weight percent by weight of the composition, a silane coupling agent in an amount of about 0.2 to about 0.5 weight percent by weight of the composition, a wax in an amount of about 0.25 to about 0.4 weight percent by weight of the composition, a surfactant in an amount of about 0.05 to about 2.0 weight percent by weight of the composition, and zinc oxide in an amount of about 0.4 to about 0.6 weight percent by weight of the composition.

In some embodiments, the compositions provided herein comprise UHMW silicone elastomer in an amount of about 1.0 to about 2.0 weight percent by weight of the composition, ethylene-vinyl acetate in an amount of about 42 to about 44 weight percent by weight of the composition, alumina trihydrate in an amount of about 52 to about 54 weight percent by weight of the composition, a peroxide in an amount of about 0.5 to about 0.6 weight percent by weight of the composition, a phenolic antioxidant in an amount of about 0.8 to about 1.0 weight percent by weight of the composition, a sulfur-containing antioxidant in an amount of about 0.05 to about 0.15 weight percent by weight of the composition, a silane coupling agent in an amount of about 0.2 to about 0.5 weight percent by weight of the composition, a wax in an amount of about 0.25 to about 0.4 weight percent by weight of the composition, a surfactant in an amount of about 0.05 to about 2.0 weight percent by weight of the composition, and zinc oxide in an amount of about 0.4 to about 0.6 weight percent by weight of the composition.

In still further embodiments, the compositions provided herein comprise UHMW silicone elastomer in an amount of about 1.0 to about 1.5 weight percent by weight of the composition, ethylene-vinyl acetate in an amount of about 42 to about 44 weight percent by weight of the composition, alumina trihydrate in an amount of about 52 to about 54 weight percent by weight of the composition, a peroxide in an amount of about 0.5 to about 0.6 weight percent by weight of the composition, a phenolic antioxidant in an amount of about 0.8 to about 1.0 weight percent by weight of the composition, a sulfur-containing antioxidant in an amount of about 0.05 to about 0.15 weight percent by weight of the composition, a silane coupling agent in an amount of about 0.2 to about 0.5 weight percent by weight of the composition, a wax in an amount of about 0.25 to about 0.4 weight percent by weight of the composition, a surfactant in an amount of about 0.05 to about 2.0 weight percent by weight of the composition, and zinc oxide in an amount of about 0.4 to about 0.6 weight percent by weight of the composition.

### Methods of Forming Compositions

Methods are provided herein for forming compositions comprising UHMW silicone elastomer. In embodiments, the methods comprise combining ethylene-vinyl acetate, alumina trihydrate, and a peroxide to form a mixture; heating the mixture to a first temperature of at least 150° F. to form a processed mixture; and combining the processed mixture with a UHMW silicone elastomer to form the composition. The first temperature, in other embodiments, may be at least 160° F., at least 170° F., at least 180° F., at least 190° F., or at least 200° F. In a particular embodiment, a practical upper limit of the first temperature is about 250° F. The first temperature, in further embodiments, may be about 150° F. to about 250° F., about 160° F. to about 250° F., about 170° F. to about 250° F., about 180° F. to about 250° F., about 190° F. to about 250° F., or about 200° F. to about 250° F.

In embodiments, the methods comprise combining ethylene-vinyl acetate, alumina trihydrate, and a peroxide to form a mixture; heating the mixture to a first temperature of at least 150° F. to form a processed mixture; heating the processed mixture to a second temperature of at least 200° F.; and combining the processed mixture with a UHMW silicone elastomer to form the composition. The first temperature, in other embodiments, may be at least 160° F., at least 170° F., at least 180° F., at least 190° F., or at least 200° F. In a particular embodiment, a practical upper limit of the first temperature is about 250° F. The second temperature, in some embodiments, may be at least 210° F., at least 220° F., at least 230° F., at least 240° F., or at least 250° F. In a certain embodiment, a practical upper limit of the second temperature is about 300° F. In further embodiments, the second temperature is about 210° F. to about 300° F., about 220° F. to about 300° F., about 230° F. to about 300° F., about 240° F. to about 300° F., or about 250° F. to about 300° F.

In embodiments, the methods further comprise adding one or more additives to the mixture.

In embodiments, a UHMW silicone elastomer is the final component added to the compositions provided herein, and the other components of the compositions or parts thereof, including the one or more additives, may be combined in any order and in any manner. In one embodiment, the entire amount of UHMW silicone elastomer is added as the final component in the methods provided herein. In another embodiment, at least a portion of the UHMW silicone elastomer is added as the final component in the methods provided herein.

In embodiments, the step of combining ethylene-vinyl acetate, alumina trihydrate, and a peroxide to form a mixture comprises [1] combining a first portion of the ethylene-vinyl acetate and a first portion of the alumina trihydrate, [2] combining a peroxide with the first portions of ethylene-vinyl acetate and alumina trihydrate, and [3] adding a second portion of the ethylene-vinyl acetate and a second portion of the alumina trihydrate to form the mixture.

In embodiments, the step of combining ethylene-vinyl acetate, alumina trihydrate, and a peroxide to form a mixture comprises [1] combining a first portion of the ethylene-vinyl acetate and a first portion of the alumina trihydrate, [2] combining a peroxide and one or more additives with the first portions of ethylene-vinyl acetate and alumina trihydrate, and [3] adding a second portion of the ethylene-vinyl acetate and a second portion of the alumina trihydrate to form the mixture.

In embodiments, the methods provided herein further comprise rolling the composition. The composition may be rolled with one or more heated rollers.

In embodiments, the methods provided herein further comprise pelletizing the composition. Any pelletizing techniques known in the art may be used.

In embodiments, the methods provided herein further comprise rolling the composition to form a rolled composition, and pelletizing the rolled composition.

In embodiments, the methods comprise combining ethylene-vinyl acetate, alumina trihydrate, and a peroxide to form a mixture; heating the mixture to a first temperature of at least 150° F. to form a processed mixture; heating the processed mixture to a second temperature of at least 200° F.; combining the processed mixture with a UHMW silicone elastomer to form the composition; rolling the composition to form a rolled composition; and pelletizing the rolled composition. The first temperature, in other embodiments, may be at least 160° F., at least 170° F., at least 180° F., at least 190° F., or at least 200° F. The second temperature, in some embodiments, may be at least 210° F., at least 220° F., at least 230° F., at least 240° F., or at least 250° F.

In embodiments, the methods comprise [1] combining a first portion of ethylene-vinyl acetate and a first portion of alumina trihydrate, [2] combining a peroxide and one or more additives with the first portions of ethylene-vinyl acetate and alumina trihydrate, [3] adding a second portion of ethylene-vinyl acetate and a second portion of alumina trihydrate to form the mixture; [4] heating the mixture to a first temperature of at least 150° F. to form a processed mixture; [5] heating the processed mixture to a second temperature of at least 200° F.; [6] combining the processed mixture with a UHMW silicone elastomer to form the composition; [7] rolling the composition to form a rolled composition; and [8] pelletizing the rolled composition. The first temperature, in other embodiments, may be at least 160° F., at least 170° F., at least 180° F., at least 190° F., or at least 200° F. The second temperature, in some embodiments, may be at least 210° F., at least 220° F., at least 230° F., at least 240° F., or at least 250° F.

In embodiments, the methods provided herein may include other steps known to those of ordinary skill in the art, including common processing steps, such as stirring.

### Composite Materials

Also provided herein are composite materials comprising the compositions disclosed herein.

In embodiments, the composite materials comprise a wire, and a composition provided herein, wherein the composition is disposed on at least a portion of the wire. The compositions provided herein may be disposed on the wires by any techniques known in the art.

The wire, in embodiments, is a conductor wire, such as a tin plated copper conductor wire. The wire, in some embodiments, is a 22 gauge wire, a 20 gauge wire, or a 14 gauge wire.

The compositions provided herein, when disposed on a wire, may have a thickness of about 0.30 mm to about 1.0 mm, about 0.40 mm to about 0.9 mm, about 0.50 mm to about 0.8 mm, or about 0.6 mm to about 0.8 mm. In a particular embodiment, the composition has a thickness of about 0.76 mm.

In one embodiment, the wire is a 22 gauge wire, and the composition disposed on the wire has a thickness of about 0.30 mm to about 1.0 mm, about 0.40 mm to about 0.9 mm, about 0.50 mm to about 0.8 mm, or about 0.6 mm to about 0.8 mm. In another embodiment, the wire is a 20 gauge wire, and the composition disposed on the wire has a thickness of about 0.30 mm to about 1.0 mm, about 0.40 mm to about 0.9 mm, about 0.50 mm to about 0.8 mm, or about 0.6 mm to about 0.8 mm. In a further embodiment, the wire is a 14 gauge wire, and the composition disposed on the wire has a thickness of about 0.30 mm to about 1.0 mm, about 0.40 mm to about 0.9 mm, about 0.50 mm to about 0.8 mm, or about 0.6 mm to about 0.8 mm.

In one embodiment, the wire is a 22 gauge wire, and the composition disposed on the wire has a thickness of about 15 mm, about 30 mm, or about 76 mm. In another embodiment, the wire is a 20 gauge wire, and the composition disposed on the wire has a thickness of about 15 mm, about 30 mm, or about 76 mm. In a further embodiment, the wire is a 14 gauge wire, and the composition disposed on the wire has a thickness of about 15 mm, about 30 mm, or about 76 mm.

In embodiments, the composite material is a wire that complies with an appliance wiring material (AWM) horizontal flame test (i.e., FT2 flame test). As used herein, the phrases “complies with an appliance wiring material (AWM) horizontal flame test (i.e., FT2 flame test)” and “complies with an FT2 flame test” refer to wires that do not produce falling particles and cotton ignition when tested in accordance with a standard test, such as UL 1581. In one embodiment, the wires provided herein comply with an FT2 flame test, and have a time to extinguish of about 5 to about 7 seconds.

In embodiments, the composite material is a wire that has an average strip force of about 13 to about 16.5 when strip force tested according to SAE J1128 at 20 inches/minutes, and removing a one inch section of insulation.

In embodiments, the composite material is a wire that complies with an FT2 flame test and has an average strip force of about 13 to about 16.5 when strip force tested according to SAE J1128 at 20 inches/minutes, and removing a one inch section of insulation.

In one embodiment, the wire is a 22 gauge wire, the composition disposed on the wire has a thickness of about 15 mm, about 30 mm, or about 76 mm, and the wire complies with an FT2 flame test and/or has an average strip force of about 13 to about 16.5 when strip force tested according to SAE J1128 at 20 inches/minutes, and removing a one inch section of insulation. In another embodiment, the wire is a 20 gauge wire, the composition disposed on the wire has a thickness of about 15 mm, about 30 mm, or about 76 mm, and the wire complies with an FT2 flame test and/or has an average strip force of about 13 to about 16.5 when strip force tested according to SAE J1128 at 20 inches/minutes, and removing a one inch section of insulation. In a further embodiment, the wire is a 14 gauge wire, the composition disposed on the wire has a thickness of about 15 mm, about 30 mm, or about 76 mm, and the wire complies with an FT2 flame test and/or has an average strip force of about 13 to about 16.5 when strip force tested according to SAE J1128 at 20 inches/minutes, and removing a one inch section of insulation.

It must be noted that, as used in the specification and the appended claims, the singular forms “a,” “an,” and “the” include plural referents unless the context clearly dictates otherwise. Thus, for example, reference to “a peroxide” includes mixtures of peroxides, and the like.

### EXAMPLES

The present invention is further illustrated by the following examples, which are not to be construed in any way as imposing limitations upon the scope thereof. On the contrary, it is to be clearly understood that resort may be had to various other aspects, embodiments, modifications, and equivalents thereof which, after reading the description herein, may suggest themselves to one of ordinary skill in the art without departing from the spirit of the present invention or the scope of the appended claims. Thus, other aspects of this invention will be apparent to those skilled in the art from consideration of the specification and practice of the invention disclosed herein.

### Example 1—Effect of UHMW Silicone Elastomer Addition Sequence

Two batches were prepared to test the effect of UHMW silicone elastomer addition sequence on FT2 flame performance and SAE strip force.

The two batches of this example were prepared using a 3L BANBURY® (Kobelco, Connecticut, USA) mixer.

In the first batch (Batch 1), the UHMW silicone was the final component added. In the second batch (Batch 2), the UHMW silicone was not the final component added. Both batches, however, included the following components:

TABLE 1
Contents of Batch 1 and Batch 2

| | Weight Percentage |
|---|---|
| | (based on weight |
| Components | of composition) |
| ULTRATHENE ® UE624000 (LyondellBasell, | 41.96 |
| Texas, USA)(ethylene-vinyl acetate (EVA)) | |
| HYDRAL ® PGA-SD (J. M. Huber, Georgia, | 53.2 |
| USA) (alumina trihydrate (ATH)) | |
| *IRGANOX ® 1010 (BASF, USA) | 0.9 |
| *NAUGARD ® 412S (Addivant, Connecticut, | 0.09 |
| USA) | |
| *Vinyltrimethoxysilane (Wacker, Munich, | 0.35 |
| Germany) | |
| *Ethylene bis(stearamide) wax | 0.32 |
| *Lauric Acid | 0.11 |
| *Zinc Oxide | 0.5 |
| VULCUP ® R Crosslinking Peroxide (Arkema, | 0.57 |
| Pennsylvania, USA) | |
| GENIOPLAST ® Pellet S (Wacker, Munich, | 2 |
| Germany) UHMW Silicone Elastomer | |

*Additive

Using the foregoing contents, Batch 1, which was prepared in accordance with some embodiments of the present disclosure, and comparative Batch 2 were made with different procedures. A comparison of the procedures used to make the first batch and the second batch appear in the following table:

TABLE 2
Preparation of Batch 1 and Batch 2

| Step | Batch 1 | Batch 2 |
|---|---|---|
| 1 | Add ½ EVA and ½ ATH | Add ½ EVA and ½ ATH |
| 2 | Add entire amounts of [1] | Add entire amounts of [1] |
| | additives, and [2] crosslinking | additives, [2] crosslinking |
| | peroxide | peroxide, and [3] UHMW |
| | | silicone elastomer |
| 3 | Add remaining ½ EVA | Add remaining ½ EVA |
| | and ½ ATH | and ½ ATH |
| 4 | Ram down (35 psi) | Ram down (35 psi) |
| 5 | Mix to 200° F. | Mix to 200° F. |
| 6 | Ram up | Ram up |
| 7 | Dust down | Dust down |
| 8 | Ram down | Ram down |
| 9 | Mix to 260° F. | Mix to 260° F. |
| 10 | Ram up | Ram up |
| 11 | Add entire amount of UHMW | N/A |
| | silicone elastomer | |
| 12 | Rollover for 1 minute | Rollover for 1 minute |
| 13 | Discharge Batch 1 | Discharge Batch 2 |

Each batch was sheeted out on a two roll mill. The front roll was set to 175° F. and the back roll to 150° F. Strips were cut from each sheet, diced, and then pelletized at 250° F.

The pellitization was performed with a HAAKE′ Rheocord extruder at 25 RPM and 125° C. for 30 minutes. The belt puller was set at 20, and the die had a 3.8 mm opening.

### Example 2—Preparation and Testing of Coated Wires

Wire samples were prepared on a laboratory continuous vulcanization (CV) line. The wires included a 20 gauge 7×28 tin plated copper conductor insulated with 0.76 mm of the composition of Batch 1 or Batch 2 of Example 1.

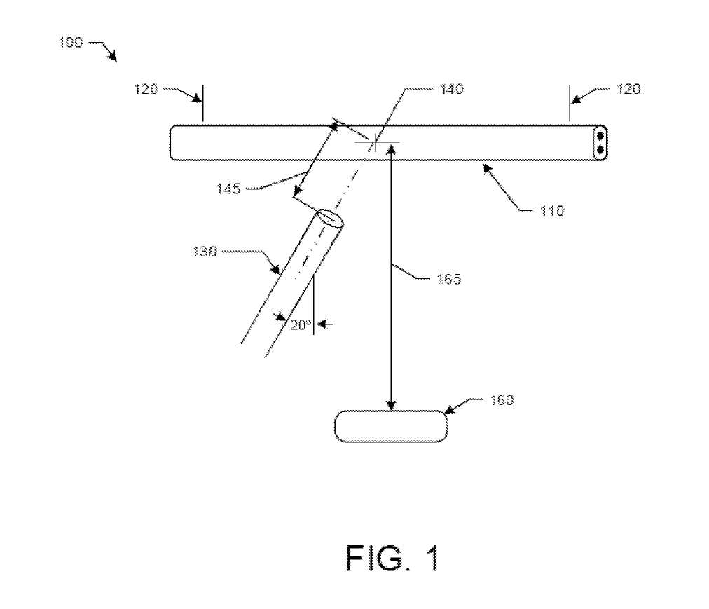

An appliance wiring material (AWM) horizontal flame test (i.e., FT2 flame test) was performed on the wires. FIG. 1 depicts the setup and several parameters of the FT2 flame test 100. The proportions of FIG. 1 are exaggerated for clarity of detail, and FIG. 1 is not drawn to scale. As depicted at FIG. 1, a 10 inch (25 mm) wire sample 110 was fixed by supports 120 spaced 9 inches (230 mm) apart. A Tirrill burner 130 was mounted 20° from vertical at a position that permitted its flame to be focused at the midpoint 140 of the wire sample 110. The tip of the burner 150 was positioned at a distance 145 of 1 9/16 inches (40 mm) from the midpoint 140 of the wire sample 110. Cotton wool 160 was placed beneath the wire sample 110, and the distance 165 between the top surface of the cotton wool 160 and the wire sample 110 was 9 to 9½ inches (230-240 mm). The FT2 flame test was conducted in accordance with UL 1581. In order to meet this standard, the horizontal wire sample 110 [1] could not convey flame along its length, and [2] could not convey flame to combustible materials (the cotton wool 160) in its vicinity after a single 30 second application of a 225 W test flame (770 Btu/h) from the burner 130.

In addition to the horizontal flame test, strip force testing also was carried out per SAE J1128 at 20 inches/minute, and removing a one inch section of insulation.

Surprisingly, the addition sequence of the UHMW silicone elastomer significantly impacted both the FT2 flame test performance and the initial and aged strip force values, because the wires coated with the Batch 1 composition of Example 1 outperformed the wires coated with the Batch 2 composition of Example 1.

The wires coated with the Batch 1 composition of Example 1 consistently met the FT2 flame requirements, with no falling particles and no cotton ignition. In contrast, two out of three specimens of wires coated with the Batch 2 composition of Example 2 suffered failures due to cotton ignition. The following table summarizes the performance of each wire.

TABLE 3
Performance of Wires Coated with Batch 1 or Batch 2 Compositions
in FT2 Test

| Coating | Specimen | Falling | Cotton | Time to |
|---|---|---|---|---|
| Type | No. | Particles | Ignition | Extinguish (s) |
| Batch 1 | 1 | None | None | 5 |
| | 2 | None | None | 7 |
| | 3 | None | None | 7 |
| Batch 2 | 1 | None | None | 7 |
| | 2 | None | Yes | — |
| | 3 | None | Yes | — |

Also, the initial and aged (3 weeks at room temperature) strip force was 4 to 5 pounds lower for the wires coated with the Batch 1 composition of Example 1, compared to the wires coated with the Batch 2 composition of Example 1. The following table summarizes the performance of each wire.

TABLE 4
Performance of Wires Coated with Batch 1 or
Batch 2 Compositions in Strip Force (SF) Test

| Coating | Specimen | Day 1 | Day 4 | Day 5 | Day 12 | Day 21 |
|---|---|---|---|---|---|---|
| Type | No. | (SF)(lbs.) | (SF)(lbs.) | (SF)(lbs.) | (SF)(lbs.) | (SF)(lbs.) |
| Batch 1 | 1 | 11.8 | 15.9 | 17.2 | 12.2 | 12.3 |
| | 2 | 12 | 17 | 14.1 | 12.8 | 12.9 |
| | 3 | 12.2 | 17.9 | 12.5 | 12.4 | 13.6 |
| | 4 | 15 | 16.7 | 11.7 | 15.8 | 14.2 |
| | 5 | 14.4 | 13.5 | 14.4 | 12.6 | 12.9 |
| | Average | 13.1 | 16.2 | 14.0 | 13.2 | 13.2 |
| Batch 2 | 1 | 16.1 | 13.9 | 18.8 | 19.3 | 23.7 |
| | 2 | 19.2 | 15.6 | 16.1 | 15.7 | 16.7 |
| | 3 | 14.9 | 17.9 | 18.7 | 20.2 | 15.6 |
| | 4 | 18.8 | 19.0 | 18.3 | 20.3 | 17.9 |
| | 5 | 17.8 | 19.4 | 11.1 | 16.9 | 18.0 |
| | Average | 17.4 | 17.2 | 16.6 | 18.4 | 18.4 |

### Example 3—Other Compositions

Several other compositions were tested according to the methods of Example 1 and Example 2. Specifically, a series of compositions were made using the Batch 1 process and the Batch 2 process. A control sample, which lacked UHMW silicone elastomer, also was made and tested. The compositions (C1, C2, C3, etc.) included the following components:

TABLE 5
Contents of Compositions

| | Wt. % | Wt. % | Wt. % | Wt. % | Wt. % |
|---|---|---|---|---|---|
| Components | C1 | C2 | C3 | C4 | C5 |
| ULTRATHENE ® | 43.19 | 42.94 | 42.69 | 42.44 | 42.19 |
| UE624 (LyondellBasell, | | | | | |
| Texas, USA) (ethylene- | | | | | |
| vinyl acetate) | | | | | |
| HYDRAL ® PGA-SD | 53.5 | 53.5 | 53.5 | 53.5 | 53.5 |
| (J. M. Huber, Georgia, | | | | | |
| USA) (alumina | | | | | |
| trihydrate) | | | | | |
| *IRGANOX ® 1010 | 0.64 | 0.64 | 0.64 | 0.64 | 0.64 |
| (BASF, USA) | | | | | |
| *NAUGARD ® 412S | 0.32 | 0.32 | 0.32 | 0.32 | 0.32 |
| (Addivant, Connecticut, | | | | | |
| USA) | | | | | |
| *Vinyltrimethoxysilane | 0.35 | 0.35 | 0.35 | 0.35 | 0.35 |
| (Wacker, Munich, | | | | | |
| Germany) | | | | | |
| *Ethylene bis | 0.32 | 0.32 | 0.32 | 0.32 | 0.32 |
| (stearamide) wax | | | | | |
| *Lauric Acid | 0.11 | 0.11 | 0.11 | 0.11 | 0.11 |
| VULCUP ® R | 0.57 | 0.57 | 0.57 | 0.57 | 0.57 |
| Crosslinking Peroxide | | | | | |
| (Arkema, Pennsylvania, | | | | | |
| USA) | | | | | |
| UHMW Silicone | 1 | 1.25 | 1.5 | 1.75 | 2 |
| Elastomer | | | | | |

(“Wt. %” based on weight of composition)
Results similar to those of Example 2 were achieved when the components of Table 5 were tested as described in Example 2.

We claim:

1. A method of forming a composition, the method comprising:
combining ethylene-vinyl acetate, alumina trihydrate, and a peroxide to form a mixture;
heating the mixture to a first temperature of at least 150° F. to form a processed mixture; and
combining the processed mixture with a UHMW silicone elastomer to form the composition,
wherein the composition comprises ethylene-vinyl acetate in an amount of about 35 to about 55 weight percent by weight of the composition, alumina trihydrate in an amount of about 45 to about 65 weight percent by weight of the composition, the peroxide in an amount of about 0.3 to about 0.8 weight percent by weight of the composition, and the UHMW silicone elastomer in an amount of about 0.1 to about 3.0 weight percent by weight of the composition, wherein ethyl-vinyl acetate, alumina trihydrate, peroxide and UHMW silicone comprise 100 percent by weight of the composition.

2. The method of claim 1, further comprising heating the processed mixture to a second temperature of at least 200° F. prior to combining the processed mixture with the UHMW silicone elastomer.

3. The method of claim 1, further comprising:
rolling the composition with one or more heated rollers to form a rolled composition; and
pelletizing the rolled composition.

4. The method of claim 1, wherein the UHMW silicone elastomer is GENIOPLAST® Pellet S silicone gum.

5. The method of claim 1, wherein the UHMW silicone elastomer is present in the composition in an amount of about 0.5 to about 2.5 weight percent by weight of the composition.

6. The method of claim 5, wherein the UHMW silicone elastomer is present in the composition in an amount of about 1.0 to about 1.5 weight percent by weight of the composition.

7. The method of claim 1, further comprising adding to the mixture one or more additives selected from the group consisting of an antioxidant, a silane coupling agent, a wax, and a surfactant, wherein each of the one or more additives is independently present in the composition in an amount of about 0.01 to about 1.0 weight percent by weight of the composition.

8. The method of claim 7, wherein the antioxidant is a phenolic antioxidant.

9. The method of claim 8, wherein the phenolic antioxidant is IRGANOX® 1010 antioxidant.

10. The method of claim 7, wherein the antioxidant is a sulfur-containing antioxidant.

11. The method of claim 10, wherein the sulfur-containing antioxidant is NAUGARD® 412s thioester antioxidant.

12. The method of claim 7, wherein the silane coupling agent comprises vinyltrimethoxysilane, vinyltriethoxysilane, or a combination thereof.

13. The method of claim 12, wherein the vinyltrimethoxysilane is GENIOSIL® XL 10 vinyltrimethoxysilane.

14. The method of claim 7, wherein the wax is ethylene bis(stearamide).

15. The method of claim 7, wherein the surfactant is a saturated fatty acid.

16. The method of claim 15, wherein the saturated fatty acid is lauric acid.

17. The method of claim 1, wherein the peroxide comprises VULCUP® R crosslinking peroxide.

18. A composite material comprising:
a wire, and
a composition made according to the method of claim 1, wherein the composition is disposed on at least a portion of the wire.

19. The composite material of claim 18, wherein the wire is a tinplated copper conductor wire.

20. The composite material of claim 19, wherein the composition has a thickness ranging from about 0.3 mm to about 1.0 mm, the wire is a 20 gauge wire, the composition has a thickness of about 0.76 mm, and the composite material complies with an FT2 flame test.
